(19) United States
(12) Patent Application Publication
(10) Pub. No.: US 2002/0141353 A1
(43) Pub. Date: Oct. 3, 2002

(54) Method and device for improving a data throughput

(76) Inventors: Reiner Ludwig, Hurtgenwald (DE); Michael Meyer, Aachen (DE)

Correspondence Address: Spencer C. Patterson, Esq., Jenkens and Gilchrist, P.C., 3200 Fountain Place, 1445 Ross Ave., Dallas, TX, 75202, US

(21) Appl. No.: 10/102,222

(22) Filed: Mar. 19, 2002

(30) Foreign Application Priority Data
Mar. 20, 2001 (EP) 01106858.2

(51) Int. Cl. H04J 1/16

(52) U.S. Cl. 370/254; 370/216

(57) ABSTRACT

The invention relates to a method and a device for improving a data throughput in a transmission via communication network, especially in a channel switch, where a newly assigned channel has a smaller transmission rate. A decision on the channel switch is taken in an administration unit, which is communicated to a provision unit. Upon receipt of the communication, the transmission parameters of an old and a new channel are stored. On the basis of the communication, an adaptation to the transmission parameters of the new channel is performed. If the communication takes place prior to the performance of the channel switch, the number of data packets transmitted is reduced so as to achieve a better adaptation and to avoid abrupt changes in the transmission rate. If the communication takes place only after the performance of the channel switch, the abrupt reduction of the transmission rate is compensated in that more data are temporarily transmitted in addition to the proportionally permitted transmission rate of the new channel.

### BACKGROUND OF THE INVENTION

1. Technical Field of the Invention

The invention relates to a method, a device and a computer program for improving a data throughput during a transmission via a communication network, in particular, if a channel switch takes place on a connection within the communication network.

2. Description of Related Art

The transmission of data between the communicating partner instances is based on standardized protocol stacks. A protocol stack is formed of several protocol layers, hereinafter also referred to as layers. The uppermost layer, the application layer, comprises applications directly used by a user. The internet use is, for example, one possible application. A transport layer with the corresponding transport protocols such as the TCP (Transmission Control Protocol) is provided underneath the application layer. The Internet Protocol (IP) is an example for the network layer. The two lowermost layers, the link layer and the physical layer, may be summarized by the term network-oriented layer, since they are specifically defined in response to the underlying network.

The transport protocol TCP provides a reliable transport service of data between two communicating partners, whereby the TCP is responsible for an end-to-end transmission, possibly via a heterogeneous connection, which may section-wise be characterized by different network topologies, transmission rates and transmission delays. Laborious mechanisms guarantee the adaptation of the transmission to the characteristics of the connection link as well as robustness against the occurrence of errors. The precise description of the TCP methods may be inferred from “TCP/IP. Illustrated, Volume 1” by W. Richard Stevens. In the following, only a few of said mechanisms will be entered into in more detail.

For the time being a method is introduced, which relates to the detection of packet losses, which may take place if errors occur or in an overload situation during a transmission.

A mechanism for the detection of packet losses is based on the so-called cumulative acknowledgement scheme by TCP. If a packet loss occurs during a transmission, the receiver becomes aware thereof by receiving a data packet, which, according to the sequence number, was not expected as the next one in the sequence. As a result, an acknowledgement message is sent to the sender, which includes the sequence number of the data packet not received. In this case, said acknowledgement messages are called duplicate acknowledgments, and the receipt of the third duplicate acknowledgment indicates the sender the loss of the corresponding data packet, whereupon a retransmission of the data packet is initiated. The receipt of three duplicate acknowledgments will be interpreted by the sender as a temporary interruption. An acknowledgement message is sent to the sender once the receiver has received another data packet, and due to the fact that additional acknowledgements are received, the sender concludes that the data packets sent after the faulty data packet were actually received. This indicates that merely the explicit sending of the faulty data packet suffices to eliminate the error. A permanent disturbance is recognized by another mechanism, which will be introduced in the following.

The TCP mechanism, which recognizes a serious loss of data packets, consists in the use of time limits. An expiration of a time limit is the so-called timeout. A time limit is associated with a time margin provided for performing a certain task. If the task is not realized within said time margin, a timeout occurs. In the case of TCP, for example, a time margin is defined, the RTT (Round Trip Time), which indicates the time passing between the delivery of a TCP packet to the IP layer and the receipt of a pertinent acknowledgement message from a receiver, that said data packet was received correctly. This time margin enables an adaptation to different transmission conditions, as said value contains a message on the present performance of a transmission. On the basis of the average value and the variance of the RTT, an RTO (Retransmission Timeout) is determined. An RTO designates the time point, at which a retransmission of a data packet takes place, for which it took longest to receive a corresponding acknowledgement message on the receipt thereof. The exact determination of the RTO can be inferred from RFC 2988, Transmission Control Protocol, November 2000. With timeout-based error recognition the exactness of the RTO calculation largely influences the data throughput. If the timeout has been scheduled too short, unnecessary data packets are retransmitted. If it is too long, excessive time passes until the loss of a data packet is noticed, which again results in time intervals during which one inactively waits for the continued transmission. The determination of an RTO takes place dynamically during a transmission so as to thereby record the RTT fluctuations in a transmission as precisely as possible. Despite said measures, the algorithm for calculating the RTO value entails problems, if abrupt fluctuations in the RTT occur. An improved algorithm has been developed, which provides more exact values for the RTO. Each time the RTO value is measured, a smoothed average value of the deviation between the previous average value of the RTT and the actually measured RTT values is additionally formed anew. If, the RTT changes abruptly, however, after merely small deviations had occurred for a longer time period in advance, also the calculated mean deviation cannot compensate the fluctuations immediately. If the RTT shows an essentially larger value than the RTO, it may be possible that the timeout for a sent data packet expires before an acknowledgement message for said data packet is received. The occurrence of timeout is evaluated as a data packet loss and, at the same time, as an indication for transmission problems. Consequently, although a data packet was transmitted and received correctly, the same is recognized as having been lost, and TCP mechanisms are started for eliminating the error and for avoiding the occurrence of additional errors. The basic idea behind said TCP mechanisms is to immediately reduce the transmission rate, at which the packets are forwarded to the communication network, when packet losses occur. Afterwards the rate is slowly increased so as to approach the actually existing network capacity.

The algorithms used for the flow control of the data packets, which avoid the occurrence of subsequent transmission errors, are called congestion avoidance and slow start algorithms. For the realization of these two algorithms, a window technique is applied. With this technique, two kinds of windows are administered by the sender; a window whereof the size was suggested and confirmed by the receiver, the advertised window, and the congestion window. The number of packets which can be sent corresponds to the minimum of both windows. The determination of the size of the congestion window takes place step by step. Upon the initiation of a connection, a sender starts to send a packet. Upon receipt of an acknowledgement message from the receiver on the correct receipt the congestion window is increased by one, and, as a consequence, two packets are being sent. After the acknowledgement messages for the two sent packets are received, four packets and so on are being sent until a window size suggested by the receiver when the connection was set up is reached, or until a packet loss has occurred. In this connection, a packet loss is detected by a timeout or by the receipt of the third duplicate acknowledgment. Upon the detection of a packet loss by means of a timeout the size of the congestion window is reduced to one segment, whereby a slow start algorithm is initiated, and the timeout is doubled over the present value. Upon the initiation of a slow start algorithm the size of the congestion window at first grows exponentially. The exponential growth is maintained until half of the original window size is reached, i.e. the window size valid before the occurrence of a packet loss. Thereafter, the growth becomes linear until a packet loss is again recognized by a timeout or by the receipt of the third duplicate acknowledgment. In other words, if a permanent disturbance takes place, the window size is set at one packet maximum, and the RTO is set at double the value of the previous RTO value. Upon the restart of the transmission the window size is regulated by the slow start algorithm, and the RTO is calculated anew in response to the RTT.

In the case where a packet loss is detected by means of duplicate acknowledgments, however, no slow start algorithm is started. Instead, the size of the congestion window is reduced by half. In this case, only the packet to which the duplicate acknowledgments refer is retransmitted, and the transmission of the following packets is continued subsequently. Said method is also known as the Fast Retransmit and Fast Recovery. An exact description thereof can be found in “TCP/IP. Illustrated, Volume 1” by W. Richard Stevens.

In other words, a detected packet loss results in a retransmission of the lost data packet and in the application of TCP methods such as the Fast Retransmit or Slow Start, which have been provided to eliminate packet losses and to avoid the occurrence of subsequent errors. A retransmission of a data packet and the application of the TCP methods, which are started upon the detection of a data packet loss, require resources and time. This has a negative effect on the transmission performance in those situations, in which a packet loss is recognized superfluously. For example, this happens if a transmission is delayed due to a short interruption, and the result may be that the receipt of an acknowledgement message takes such a long time that, in the meantime, a timeout expires and consequently a packet loss is recognized. In reality, however, the packet is received. Since, however, a packet loss was detected, the data packets already sent and correctly received are unnecessarily retransmitted and TCP mechanisms associated therewith are unnecessarily started. The superfluous occurrence of a timeout expiration is called spurious timeout, and the retransmission of already sent packets takes place according to the go-back-N algorithm.

This becomes particularly problematical in communication networks characterized by high fluctuations in the transmission rates. Part of said networks are cellular networks such as the GSM (Global System for Mobile Communication), GPRS (General Packet Radio Service); UMTS (Universal Mobile Telecommunication System), EDGE (Enhanced Data rates for GSM Evolution) or IMT-2000.

The spurious occurrence of a timeout expiration often takes place especially in mobile networks, however, above all, if sudden delays in the transmission occur due to a channel switch. A channel switch may occur due to a change between communication networks, for instance, due to a change from UMTS to GSM or from WLAN (Wireless Local Area Network) to GPRS. A channel switch may also take place in a communication network, for example, due to a handover. Another cause for the channel switch may be based on the priorities for the treatment of different users. The users, who make a phone call, often have a higher priority than users carrying out a data transfer. Therefore, if new users wanting to make a phone call join in, the data users can be shifted to other transmission channels. The channels are characterized by transmission parameters such as the transmission rate or the packet size, and a channel switch may, for example, result in different transmission rates, or at least lead to other RTTs measured on the link layer and, thus, possibly to the expiration of the timeout on the corresponding layers. A user may, for example, be shifted from one channel having a high transmission capacity to a channel having a smaller transmission capacity.

The changes associated with the channel switch on the physical layer are noticed by the transport layer, especially the TCP, only after the channel switch has taken place, namely because an abrupt change in the RTT is recorded. Said changes may result in that a timeout is exceeded and thus in a retransmission of a data packet and in the start of the corresponding methods relating to the elimination of the occurred transmission error and to the avoidance of the occurrence of additional transmission errors. The channel switch commonly does not entail a data packet loss. For this reason, the determination of the packet loss by a timeout expiration and the performance of the TCP mechanisms started with the determination are superfluous. These mechanisms require resources and a long time, resulting in the reduction of the transmission throughput. For example, given the slow start algorithm, the transmission capacity available is not optimally exploited due to the slowly increasing window size.

In accordance therewith it is the object of the present invention to provide a method and a device guaranteeing an optimized exploitation of the transmission capacity being available. The object of the present invention especially relates to an optimized use of the transmission capacity being available in a channel switch.

### SUMMARY OF THE INVENTION

The present invention relates to a method and a system for improving a data throughput in a transmission via communication network, especially in a switching of a channel, where a newly assigned channel has a smaller transmission rate. A decision on the switching of the channel is taken in an administration unit, which is communicated to a provision unit. Upon receipt of the communication, the transmission parameters of an old and of a new channel are stored. On the basis of the information contained in the transmission parameters, an adaptation to the transmission parameters of the new channel is performed. If the communication takes place prior to the switching of the channel, the number of data packets transmitted is reduced so as to achieve a better adaptation and to avoid abrupt changes in the transmission rate. If the communication takes place only after the switching of the channel, the abrupt reduction of the transmission rate is compensated in that more data are temporarily transmitted in addition to the proportionally permitted transmission rate of the new channel.

It is thereby an advantage that a superfluous adaptation of the protocols of the higher layers is avoided, so that the resources during a transmission are exploited in a more favorable manner.

### BRIEF DESCRIPTION OF THE DRAWINGS

In the following, the invention will be explained in more detail by means of examples and figures, wherein

FIG. 1 shows a flow chart according to the present invention;

FIG. 2 illustrates a connection via a communication network;

FIG. 3a is a schematic illustration of the transmission rates of two channels;

FIG. 3b shows pre-scheduling;

FIG. 3c shows post-scheduling by using an additional channel; and

FIG. 3d shows post-scheduling with a commonly used channel.

### DETAILED DESCRIPTION OF THE INVENTION

A channel switch during a transmission, or an assignment of channels during a connection set-up takes place in a communication network by means of an administration unit for administering channels and a provision unit for providing, distributing and sending data via the channels. The channels are characterized by transmission parameters. The term transmission parameter covers different quantities such as the transmission rate, the packet size, the processing time, which designates the delay time with the sender and the recipient due to the data processing. Additional transmission parameters will hereinafter be dealt with in more detail. The transmission parameters cause the delay time of the packets, and the adaptation of the transmission parameters influences the adaptation of the packet delay times. In this respect the packet delay time stands for the delays in the transmissions of data packets, which may, for example, be caused by the reduction in the transmission rate. For this reason, the definitions introduced in this connection will in the following be used alternatively, unless it is explicitly mentioned as to which transmission parameters are concerned.

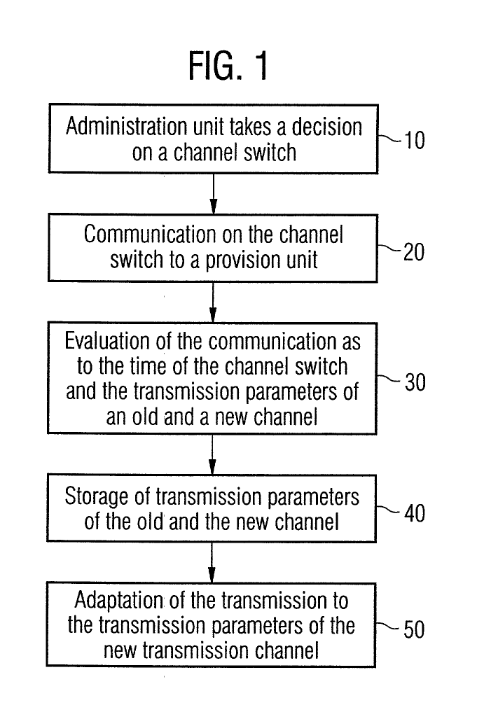

According to FIG. 1, a decision on the channel switch (i.e., switching of a channel) is taken by the administration unit in a first step 10. The administration unit has the necessary information and corresponding algorithms, which assist in taking the decision. This decision, which contains the time of the channel switch and the transmission parameters of a new and an old channel, is communicated to a provision unit, 20. The provision unit evaluates the communication of the decision, whereby it is especially evaluated as to whether a channel switch is to be carried out immediately or delayed, 30. On the basis of this evaluation, an adaptation of the transmission parameters is realized either before or after the performance of the channel switch (i.e., the operation of switching of the channel). Another possibility provides for the realization of the adaptation both before or after the performance of a channel switch. The adaptation 50 takes place on the basis of the determination of the data packets to be transmitted. For this purpose, the packet delay time caused by the transmission parameters of the new channel as well as of the old channel are taken into account. If it is, for instance, established that the packet delay time of the new channel is longer, the packet delay time of the old channel is deliberately increased prior to the performance of the channel switch, namely by providing and transmitting fewer data packets. In the case where a channel switch has already taken place, the packet delay time is reduced by temporarily transmitting more data packets, for example, via an additional data channel.

In order to realize an adaptation of the transmission parameters of channels having different packet delay times, a storage of the transmission parameters of the old or/and the new channel has to be performed, e.g. by means of storing the transmission parameters in memory provided for said purpose, 40. In the case where a channel switch has already taken place, the transmission parameters of the old channel are secured so as to guarantee a subsequent adaptation of the transmission parameters to the conditions of the new channel on the basis of the transmission parameters of the old and the new channel. In the case of a forthcoming channel switch, the storage of the transmission parameters of the new channel takes place such that an adaptation of the transmission parameters of the old channel, which, at this time, is still in use, to the transmission parameters of the new channel used after the performed channel switch is guaranteed.

A system including an administration unit for administering channels and a provision unit for providing data for the transmission via the channels is provided for the realization of the inventive solution to improve a data throughput of a transmission via a communication network. The system has a decision means, which is, for example, disposed in the administration unit. The decision means takes a decision on a channel switch. The decision is communicated to the provision unit by means of a communication means. Upon the receipt of the communication, the transmission parameters of an old channel and a new channel are stored in a memory. This is preferably performed in the provision unit. On the basis of the transmission parameters of the old channel and the new channel, an adaptation of the transmission of the old channel to the transmission parameters of the new channel is performed by an adaptation means.

In the following the invention will be explained in more detail by means of an embodiment, whereby the embodiment exemplarily relates to a UMTS network. For this purpose, a network system is used, which will here briefly be explained in a schematic manner. The UMTS network comprises user equipment being able to communicate via an UTRAN (UMTS Terrestrial Radio Access Network) with the CN (Core Network). The user equipment, hereinafter also referred to as mobile station, may be a UMTS terminal. The mobile station communicates with a node B via a radio connection. Node B is connected to an RNC (Radio Network Controller), being part of the UTRAN. The RNC is connected to the CN. Another unit, a gateway GGSN is responsible for communication with an external network, for example, another mobile network or the Internet.

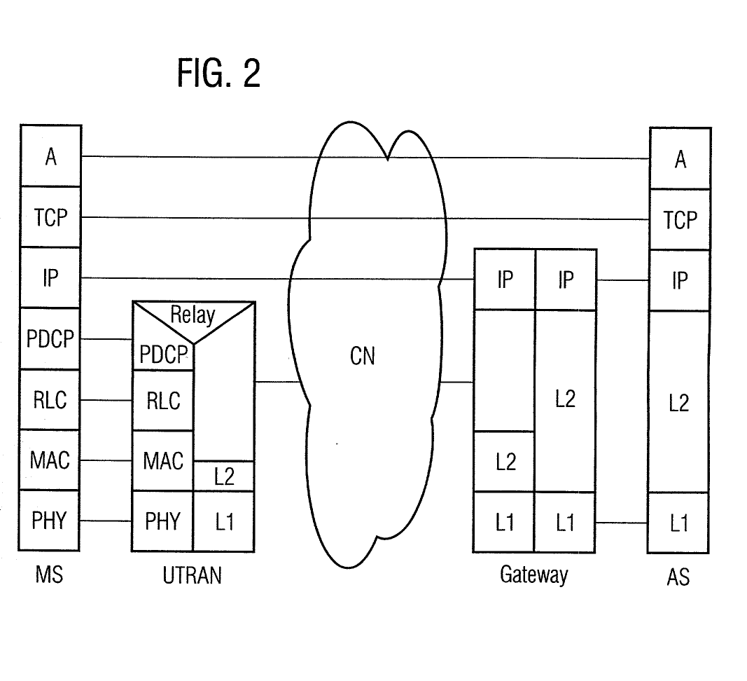

In the following the network-oriented layers of the protocol stack of a mobile station and a UTRAN are explained in more detail by means of FIG. 2. FIG. 2 illustrates schematically a connection between a mobile station MS and a server AS. As was described above, a UTRAN (UMTS Terrestrial Radio Access Network), a CN (Core Network) and a gateway are involved in the connection. Except for the CN, the units (i.e., the UTRAN, the gateway, the MS, and the AS) are illustrated as protocol stacks. As has already been described, a protocol stack consists of several protocol layers. The protocol layers are, according to FIG. 2, correspondingly designated in the respective protocol stacks of the units. The protocol stack of the MS, for example, contains an application layer A. Thereunder are provided the transport layer TCP, then the network layer IP and thereunder the network-oriented layers. The network-oriented layers contain a convergence protocol PDCP (Packet Data Convergence Protocol), a thereunder integrated RLC (Radio Link Control) layer, an MAC (Medium Access Control) layer and a physical layer (PHY). A similar structure of the network-oriented layers is likewise contained in the UTRAN. The continuous connecting lines point to the logic connections between the respective layers. As an example it can be seen from FIG. 2 that a TCP connection is an end-to-end connection. The network-oriented layers of the MS and UTRAN will be dealt with in more detail in the following. The network-oriented layers of the remaining units have merely been pointed out by the hints L1 and L2, as a detailed structure of said protocol layers is associated with the underlying network (CN) and is irrelevant in this respect.

A PDCP constitutes the interface between the network layer, e.g. the Internet protocol (IP) layer and the RLC layer. The PDCP's task hereby consists in the conversion, especially in the segmentation, of the IP packets into smaller data packets. With each connection set-up one or several RLC instances are activated on the RLC layer, which is regulated by the RRM (Radio Resource Management). The RLC layer is, inter alia, responsible for the subdivision of the received data into smaller data packets. On the basis of the data packets the correction of the errors can take place.

The MAC layer is responsible for the mapping of the logical channels to the transport channels, which includes the multiplexing of the logical channels, the distribution of the data onto the different logical channels as well as the change of the logical channels onto the available transport channels on the basis of the decision taken in the RRM. In this connection, different kinds of the logical channels are distinguished in response to the used service. For example, a difference is made between the kind of information to be transmitted, user data or control data. The control data are transmitted by control channels. The Broadcast Control Channel (BCCH), for instance, transmits network information to the terminals being present in a cell and not coupled to the network, in other words, the terminals dispose of a channel connection. The different control channels of the MAC layer will not be dealt with in more detail at this point.

The traffic channels transmit user data, whereby a difference is made between a DTCH (Dedicated Traffic Channel) and a CTCH (Common Traffic Channel). A DTCH is exclusively assigned to a terminal, so that the user data are transmitted exclusively by the DTCH. In contrast thereto, the CTCH is destined for the transmission of data to a plurality of users.

Another differentiation in the division of the channels is made in view of the transmission direction. The data are either transmitted from the network to the user, which, in this case, is the downlink, or the data are transmitted from the user to the network, in which case the transmission takes place on the uplink. In this connection, there are channels being provided for either direction or for one direction only.

A similar differentiation with regard to the available channels in view of the transmission direction and the common or exclusive use of the transmission resources is likewise made between the transport channels, which are defined between the MAC layer and the physical layer. In this respect, a difference is made between the exclusively assigned channels, the DCH (Dedicated Channels) and the CCH (common channels). The DCH channels are used on both, the uplink and the downlink. The DCH is exclusively assigned to a user for a transmission, and the stability of the DCH channel is permanently controlled during a transmission so as to guarantee a quality of the radio transmission as constant as possible. This means, an exclusive assignment of the radio resources to a user takes place during a transmission. In contrast thereto, the radio resources are shared between the different users as far as the CCH channels are concerned.

In the following, the different commonly used transport channels, which are relevant for the present invention, will be introduced. A RACH (Random Access Channel) and a CPCH (Common Packet Channel) are available on the uplink. The RACH is responsible for the initiating network access including the connection set-up on the physical layer associated therewith. In addition, it is provided for supporting the transmission of the user data. Said task is likewise fulfilled by the CPCH.

On the downlink, a FACH (Forward Access Channel) is responsible for the transport of both, the control data and the user data. By means of a DSCH (Downlink Shared Channel), the user data may additionally be transmitted to an exclusively dedicated channel, the DCH. The DSCH is proportionally used between the DCHs, for which it has been assigned.

The RRM's task, which is located in an RNC node, consists, inter alia, in the configuration of the radio resources in response to the characteristic and quality of the requested service. This means that the decision on a channel switch or on the channel assignment in a connection set-up is taken by the RRM. The decisions relate to both, namely the transmission on the uplink as well as on the downlink, and serve the regulation of an efficient compensation between the available transmission capacity on the transmission links and the requests made by the users using the resources of the transmission links.

By means of different algorithms, which need not be discussed here in more detail, the RRM determines as to when and in which form the channel switch has to take place. When applying said algorithms, for example, the performance budget of the mobile station and of the cell are taken into account. By using the defined threshold values the RRM takes a decision on the channel switch. In this respect, the algorithms comprise a corresponding hysteresis, which avoids switching back and forth too frequently. The taken decision is reflected in the form of parameters, which, among others, are forwarded to the RLC layer. The parameters in question are the transport formats such as the data rate, and the used algorithms such as the method for a retransmission of data packets.

In the following, the function of an MAC layer will be dealt with. The MAC layer is responsible for the distribution of data packets received from the RLC layer to the physical connection by taking into account the permitted transmission rate. The distribution will hereinafter be referred to as scheduling, and the function performing the same on the MAC layer will be referred to as MAC scheduler. The MAC layer, moreover, receives the transmission parameters from the RRM. The transmission parameters are, among others, a TFS (Transport Format Set), a TFCS (Transport Format Combination Set), the priorities of the logical transmission channels and the mapping of the logical transmission channels onto the transport channels. The distribution of the data packets to the physical connection is performed on the basis of said information.

In the following, the term TFS will briefly be dealt with more closely. On the MAC layer, one or more transport formats in the form of transport format set, the TFS, is/are assigned to each transport channel. A transport format contains, for instance, information on the channel coding type, the depth of the interleaving or the transmission rate for the data, or, more precisely, the number of the data which may be transmitted on the radio layer in a frame. For example, a TFS of the form (12, 8, 4, 2, 1) indicates that the transport channel, to which said set is assigned, can transmit either 12 or 8 or 4 or 2 or 1 data packet of the RLC layer in a frame on the radio layer. This means, on one hand, that the MAC layer has the information on the number of the data packets which can be sent in a TTI, whereby the TTI (Transmission Time Interval) designates the time, which was defined for the transmission of a frame. On the other hand, the MAC layer receives from the RLC layer the information on the data packets being available for the transmission, which are stored in an RLC buffer. The availability of both information causes the MAC layer to perform the scheduling algorithm.

In the UMTS it is possible to perform the channel switch in different ways. It is provided to change the transmission of the user data from a DCH to another DCH. In this connection it may occur that the transmission rate and/or the TTI of the newly assigned DCH differs from the DCH that was used last. Another possibility is to switch the transmission of the user data from a DCH to a CCH channel, whereby it has to be considered that the entire transmission rate of a CCH may be higher than that of a DCH. The user does not have, however, an exclusive possibility to use the channel, since the channel is shared with other user with the result that the effectively used transmission capacity can be smaller than the transmission capacity of the previously used DCH had guaranteed. A sharing of the CCH between several users is specified by the scheduling algorithm used.

As was already described, the channel switch may result in performance losses of the higher layers, e.g. the TCP layer, especially if the switch from a channel having a higher transmission rate to a channel having a lower transmission rate is performed abruptly. If the transmission rate is low, fewer packets are transmitted, which entails a long time interval between the transmission of a packet and the receipt of an acknowledgement message. This, again, results in that the time for the release of the packet from a higher protocol layer, e.g. the TCP, turns out to be long for a transmission.

The solution according to the invention suggests to more efficiently utilize the information on the channel switch, e.g. the time of the channel switch and the transmission parameters. In this respect, the transmission parameters of a new channel may have a relative or an absolute value over an old channel. On the basis of said information the data flow may be adapted to the properties of the new channel. If this is conferred to the introduced embodiment, the MAC layer is communicated the information on the channel switch by the RRM. On the basis of the transmission parameters, e.g. on the basis of the transmission rate of the old channel, i.e., the previously used channel, and of the newly assigned channel, the number of data packets to be transmitted via the physical connection is defined. The data are transmitted into the TTI. The time of the performance of a channel switch is used for applying a corresponding method. The solution according to the invention makes a difference between two embodiments, namely in response to the times at which the information flow takes place. If the MAC layer has the information on a forthcoming channel switch, the transmission parameters of the old channel are adapted to the expected packet delay time of the new channel. In the following, the term pre-scheduling will be used for this event. Another embodiment deals with the event, when the information on the channel switch is utilized only after the performance thereof through the MAC layer. In this connection, the term post-scheduling is used.

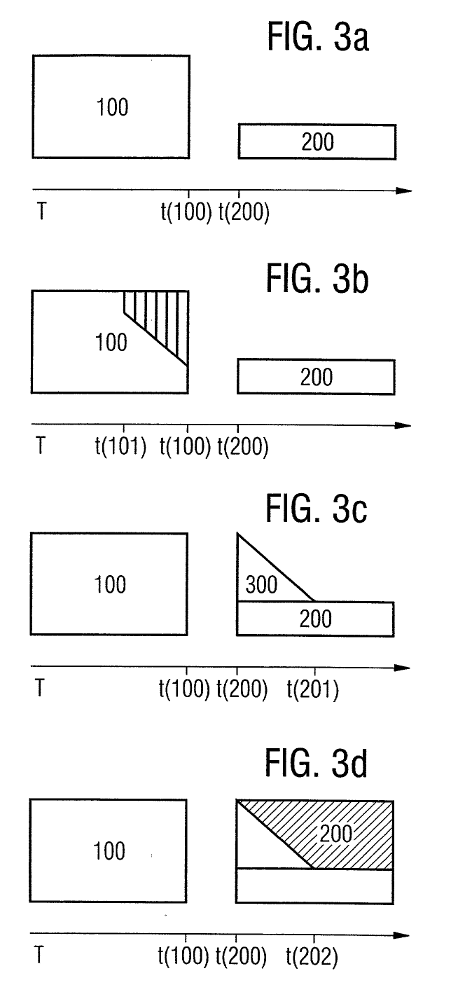

The invention will hereinafter be explained in more detail by means of FIGS. 3a and 3b.

FIG. 3a schematically illustrates the transmission rate of two channels. The left-hand square shows the high transmission rate of the old channel, and the left-hand square shows a new channel having a low transmission rate. The free section between the squares indicates a channel switch during which no data can be transmitted, but an exchange of the signaling messages takes place. The course in terms of time is illustrated by a time axis T provided underneath the figure. The channel switch takes place between time t (100) and t (200).

FIG. 3b illustrates a pre-scheduling. The striped part of the left-hand square points to the unused transmission rate of the old channel so as to thereby adapt the transmission rate of the old channel to the transmission rate of the new channel. This is to say that as of time t (101) fewer data packets are transmitted. The data rate is reduced until time t (100) until the same is adapted to the transmission rate of the new channel. By means of the pre-scheduling, the number of the data packets passed on to the transport channel are controlled. In the case where the transmission rate of the newly assigned channel is lower than the data rate of the presently used channel, the number of the data packets transmitted per time unit, e.g. TTI, is reduced. If, for example, a channel switch from a channel having the transmission rate of 384 kbit/sec to one merely having 64 kbit/sec for the transmission has to be performed, a slow adaptation of the higher transmission rate to the lower transmission rate is initiated in accordance with the invention. In other words, the data are, for example, transmitted at 256 kbit/sec at first, then at 128 kbit/sec and eventually at 64 kbit/sec. This, again, means, although the MAC scheduler could transmit more data packets, it provides fewer data packets for the transmission. In this connection, the provision of the data packets constitutes a withdrawal of the data packets from an RLC buffer. A slower withdrawal of the data packets from the RLC buffer influences the TCP, as the fact that fewer RLC data packets are transmitted results in that the acknowledgement message for a TCP packet is generated later on the receiver's side, thereby also arriving later on the sender's side. This entails that the RTT measurements, i.e. the time between the transmission of a TCP data packet and the receipt of an acknowledgement for the receipt of said data packet has a greater value. In this manner the TCP learns about the reduction in the transmission rate. The increased RTT especially effects an increase of the RTO. In this embodiment, the designation “presently used channel” corresponds to the above-chosen designation “old channel” and corresponds to the event of the pre-scheduling in a more favorable manner.

For the adaptation of the transmissions, different methods may be applied, which, for instance, reduce the transmission capacity differently fast. In case of these methods, attention has to be paid that, on one hand, not too much transmission capacity remains unused and that, on the other hand, an abrupt change in the transmission parameters is avoided so as to prevent the expiration of the timeout.

In the case where the MAC layer receives information on the forthcoming channel switch, it can control the transmission in accordance with the invention, and slowly initiate the adaptation in that the MAC scheduler does not completely exploit the transmission rate of the used channel, as would be possible, but by slowly adapting the present transmission parameters to the transmission parameters of the newly assigned channel before the channel switch takes place. This is achieved in that fewer data packets than would basically be possible are provided for the transmission. The information on the number of data packets, which can basically be transmitted, is contained in the TFS. With these steps, the entire transmission of the TCP is slowly adapted at the same time. This method requires that the transmission parameters of the new channel are known in advance. This information is available to the RRM and the task is to communicate this information to the MAC layer, so that the required steps are performed. It is the task of the MAC layer to store the corresponding transmission parameters. Due to the fact that the MAC layer receives said information before the channel switch takes place, it has both, namely the transmission parameters of the presently used channel and those of the newly assigned channel. On the basis of this information, the slow adaptation of the transmissions prior to the performance of the channel switch is obtained.

Due to the fact that the packet delay time of the presently used channel is artificially manipulated, especially increased, the artificial generation of a longer packet delay takes place on the TCP layer by step-wise measuring longer RTTs. The latter are likewise step by step considered when calculating the RTO resulting in the avoidance of spurious timeouts. As a consequence, the superfluous transmission of packets is avoided, where a packet loss is recognized erroneously, and the performance of mechanisms started upon the recognition of a data packet loss is avoided. In this manner, transmission resources and time are saved.

In some situations the channel switch has to be performed immediately, so that the time to carry out a pre-scheduling is not sufficient. In this case it is suggested by the invention to influence the scheduling of the data packets on the MAC layer after the performance of the channel switch. If the channel rate of the new channel is smaller, the abrupt reduction of the transmission rate must be compensated by transmitting more data in addition to the proportionally permitted transmission rate of the new channel. This can be inferred from FIGS. 3c and 3d.

FIG. 3c shows an event, where more data are transmitted by means of an additional channel. The additional channel, or respectively the used capacity of the additional channel, is illustrated by the triangle 300. The additional channel is used until the transmission rate of the old channel is adapted to the transmission rate of the new channel, which happens at a time t (201). In other words, an adaptation of the TCP also takes place between times t (200) and t (201). This may, for example, extend to several TCP data packets. With this method, it is required to store the transmission parameters of the old channel. During the post-scheduling, the MAC layer performs the channel switch, and only thereafter will the adaptation be initiated. In other words, the newly assigned channel is already being used, and the MAC layer, therefore, has the transmission parameters of the newly assigned channel. The transmission parameters of the old channel, i.e. of the channel used prior to the performance of the channel switch, were stored. For this reason, the MAC layer has the parameters of the old and the new channel, and an adaptation of the transmissions is carried out on the basis of this information.

The forms of realization of the post-scheduling vary between the uplink and the downlink as well as between the switching to a DCH or to a CCH. UMTS provides for the DSCH channels. As was already described, the latter relate to channels, which can proportionally be used in addition to a DCH so as to transmit data on the downlink.

The solution according to the invention provides to temporarily use said channels for the transmission on the downlink, if a channel switch takes place, so as to achieve a better adaptation of the transmission rates. In this case, the sharing of the DSCH between the users, who used the channel at that given time, has to be controlled. As an example, the priority principle with the preference of those users, with whom a channel switch has taken place, may be applied in this respect.

A similar principle may likewise be applied in the case of a channel switch from a DCH to a CCH. In this case, the entire rate of the CCH channel may be larger than the transmission rate of a DCH, however, due to the fact that the CCH is shared between several users, the transmission rate assigned to a user on the CCH after a channel switch may be essentially smaller than the rate, which was available to the user prior to the channel switch on the DCH used last. The solution according to the invention suggests to assign the user temporarily, i.e. until the transmission has adapted to the transmission rate of the newly assigned channel, a larger share of the broadband in the CCH than was actually planned for the user. This requires the application of a priority principle, which prefers those users, with whom a channel switch has taken place, whereby the rule of a fair treatment for all users of a CCH is violated in the favor of one user. Due to the fact that the solution according to the invention guarantees, after a channel switch, the avoidance of the unnecessary performance of TCP mechanisms started upon the recognition of a packet loss, the number of the retransmissions occurring with abrupt interruptions is reduced. This results in that the transmission capacity of the CCH channel assigned to a user is used more optimally, and for this reason the entire transmission capacity of the CCH is used more effectively, which eventually results in higher transmission capacities being available to all users of the CCH. This event is illustrated in FIG. 3d. Between times t (200) and t (202), an adaptation to the capacity assigned to a user takes place starting at time t (202). In other words, until time t (202) more capacity is made available to a user than he is actually allowed to have.

A third embodiment of the inventive solution provides for a combination of the pre- and post-scheduling, i.e. given a punctual report on a forthcoming channel switch, the pre-scheduling is performed first and the post-scheduling is applied after the performance of the channel switch.

The pre-scheduling proves to be advantageous when taking into account the time delays associated with the channel switch, namely in the determination of the data quantity to be transmitted. During a channel switch between t (100) and t (200) signaling messages are exchanged, which require time and, therefore, result in time delays, which may be taken into account during the pre-scheduling.

For the realization of the invention it is necessary that the RRM unit signalizes the channel switch to the MAC unit. In UMTS it is, however, feasible that the MAC unit is located in different network nodes, preferably in RNC or in a mobile station. In the following, different cases in response to the location of the MAC layer will be described as examples.

If the MAC unit and the RRM unit are located in the same network node, the invention is guaranteed to function. If the MAC unit is, for instance, located in the terminal of the user, a signaling to the MAC layer is required. It is likewise required to inform the MAC layer, if the same is provided in an RNC other than that where the RMM was located. In this case, a signal must be sent via the interface between the RNCS.

Furthermore, the invention relates to a computer program stored on a computer-readable medium or in a form, which can be loaded in a working memory of a computer, whereby the computer program controls a device.

What we claim is:

1. A method for improving data throughput of a transmission via a communication network, said method comprising the steps of:
deciding on a switching from a first channel to a second channel;
communicating the decision to a provision unit;
providing information on transmission parameters of the first channel and the second channel and on a time of said switching to the provision unit;
performing said switching from the first channel to the second channel; and
adapting the transmission parameters of the first channel to the transmission parameters of the second channel based on said information.

2. The method according to claim 1, wherein the adapting of the transmission parameters is carried out before the switching of the channel.

3. The method according to claim 1, wherein the step of adapting comprises controlling a number of data packets transmitted in a time unit.

4. The method according to claim 3, wherein the step of adapting further comprises, when the transmission parameters cause a long packet delay time, reducing the number of data packets provided for the transmission prior to the switching of the channel.

5. The method according to claim 3, wherein the step of adapting of the transmission parameters is carried out after the switching of the channel.

6. The method according to claim 3, wherein the step of adapting further comprises temporarily transmitting, when the transmission parameters cause a long packet delay time, more data in addition to a proportionally permitted transmission capacity after the switching of the channel.

7. The method according to claim 6, wherein additional data are transmitted via one or more additional channels.

8. The method according to claim 6, further comprising temporarily providing a higher transmission capacity in a channel for the transmission of more data.

9. The method according to claim 1, further comprising, prior to the step of adapting, storing the transmission parameters.

10. The method according to claim 1, wherein the switching of the channel is performed on an exclusively used channel.

11. The method according to claim 1, wherein the switching of the channel includes switching to a channel commonly used by several users.

12. The method according to claim 1, wherein the transmission parameters includes at least one of a transmission rate, a packet size, and a data processing delay.

13. A system for improving a data throughput of a transmission via a communication network comprising:
an administration unit for administering channels having transmission parameters, said administration unit deciding on a switching of a channel and communicating the decision to a provision unit; and
said provision unit for providing, distributing and transmitting data via the channels, said provision unit comprising:
a memory capable of storing the communicated decision, said decision including transmission parameters of an old channel and a new channel; and
an adaptor for adapting the transmission parameters of the old channel to the transmission parameters of the new channel.

14. The system according to claim 13, wherein the administration unit and the provision unit are located in a network node.

15. The system according to claim 13, wherein the administration unit and the provision unit are located in different network nodes.

16. The system according to claim 15, wherein a signaling link between the provision unit and the administration unit is provided for transmitting the decision.

17. A computer readable medium having a computer readable program code stored thereon for improving data throughput of a transmission via a communication network, said computer readable program code comprising instructions for:
deciding on a switching from a first channel to a second channel;
communicating the decision to a provision unit;
providing information on transmission parameters of the first channel and the second channel and on a time of said switching to the provision unit;
performing said switching from the first channel to the second channel; and
adapting the transmission parameters of the first channel to the transmission parameters of the second channel based on said information.

18. The computer readable medium of claim 17, wherein the instructions for adapting comprise instructions for controlling a number of data packets transmitted in a time unit.

19. The computer readable medium of claim 17, further comprising, when the transmission parameters cause a long packet delay time, an instruction for reducing the number of data packets provided for the transmission prior to the switching of the channel.

20. The computer readable medium of claim 17, wherein the adapting instruction further comprising, an instruction for temporarily transmitting, when the transmission parameters cause a long packet delay time, more data in addition to a proportionally permitted transmission capacity after the switching of the channel.
